(19) United States
(12) Patent Application Publication
(10) Pub. No.: US 2013/0042836 A1
(43) Pub. Date: Feb. 21, 2013

(54) FUEL INJECTOR ADAPTER DEVICE AND METHOD

(71) Applicants: Bradley Trembath, Chapel Hill, NC (US); Art Holbert, Madison, OH (US); David Lopez, Cleveland, OH (US)

(72) Inventors: Bradley Trembath, Chapel Hill, NC (US); Art Holbert, Madison, OH (US); David Lopez, Cleveland, OH (US)

(73) Assignee: INTELLECTUAL PROPERTY HOLDINGS, LLC, Cleveland, OH (US)

(21) Appl. No.: 13/588,633

(22) Filed: Aug. 17, 2012

Related U.S. Application Data
(60) Provisional application No. 61/524,576, filed on Aug. 17, 2011.

(51) Int. Cl. F02M 61/14; B23P 11/00

(52) U.S. Cl. 123/470; 29/888.011

(57) ABSTRACT

The present application discloses an engine configured to selectively operate using a first fuel and a second fuel and adapter devices and methods for converting an engine to operate using a second fuel. In certain embodiments, the adapter device comprises a body member configured to be installed between an upper intake manifold and a lower intake manifold of an engine. A plurality of intake channels and fuel injector ports are formed in the body member. The body member is configured such that the intake channels are substantially aligned with the corresponding intake openings of the upper and lower intake manifolds when the body member is installed between the upper and lower intake manifolds. Each fuel injector port extends from a sidewall of the body member to at least one intake channel and is configured to receive a fuel injector for emitting a second fuel into the intake channel.

### CROSS REFERENCE TO RELATED APPLICATIONS

This application is a U.S. Non-Provisional patent application which claims priority to U.S. Provisional Patent Application No. 61/524,576, filed on Aug. 17, 2011 and titled “Alternative Fuel Injector Adapter Device and Method,” which is hereby incorporated by reference in its entirety.

### BACKGROUND

Gasoline fuel injectors for an internal combustion engine are generally mounted in the intake port of the engine. The fuel injector injects gasoline into the intake port where the gasoline is mixed with air. The resulting mixture is then delivered to a combustion chamber of one or more cylinders of the engine. Gasoline engines may be converted to operate using compressed natural gas (“CNG”).

### SUMMARY

The present application discloses an engine configured to selectively operate using a first fuel and a second fuel and adapter devices for converting an engine to operate using a second fuel. The present application also discloses methods for converting an engine to operate using a second fuel.

In certain embodiments, an adapter device for converting an engine to operate using a second fuel is disclosed. The adapter device comprises a body member configured to be installed between an upper intake manifold and a lower intake manifold of an engine. A plurality of intake channels and fuel injector ports are formed in the body member. The body member is configured such that the intake channels are substantially aligned with the corresponding intake openings of the upper and lower intake manifolds when the body member is installed between the upper and lower intake manifolds. Each fuel injector port extends from a sidewall of the body member to at least one intake channel and is configured to receive a fuel injector for emitting a second fuel into the intake channel. In one exemplary embodiment, the fuel injector port positions a discharge end of the fuel injector such that the second fuel is emitted directly into the intake channel. In another exemplary embodiment, the fuel injector port positions a discharge end of the fuel injector such that the second fuel is emitted into an injector channel of the fuel injector port that is in fluid communication with the intake channel. The injector channel is curved to provide a laminar flow of the second fuel through the injector channel and into the intake channel.

In certain embodiments, an engine configured to selectively operate using a first fuel and a second fuel is disclosed. The engine comprises an upper intake manifold having a plurality of upper intake manifold openings; a lower intake manifold having a plurality of lower intake manifold openings; and an adapter device having a body member positioned between the upper and lower intake manifolds. A plurality of intake channels and fuel injector ports are formed in the body member. The body member is configured such that the intake channels are substantially aligned with the corresponding intake manifold openings of the upper and lower intake manifolds. Each fuel injector port extends from a sidewall of the body member to at least one intake channel and is configured to receive a fuel injector for emitting a second fuel into the intake channel.

In certain embodiments, a method for converting an engine to operate using a second fuel is disclosed. The method comprises removing the upper intake manifold of the engine and installing an adapter device on the lower intake manifold of the engine. The adapter device comprises a body member. A plurality of intake channels and fuel injector ports are formed in the body member. Each fuel injector port extends from a sidewall of the body member to at least one intake channel. A plurality of fuel injectors are installed in the fuel injector ports of the adapter device. The fuel injectors are configured to emit the second fuel into the intake channels of the adapter device. The fuel injectors are connected to at least one fuel source configured to supply the second fuel to the fuel injectors. The upper intake manifold is installed on the adapter device and secured to the adapter device and the lower intake manifold.

### BRIEF DESCRIPTION OF THE DRAWINGS

FIG. 1A is a front top perspective view of one embodiment of an adapter device.

FIG. 1B is a front bottom perspective view of the adapter device shown in FIG. 1A.

FIGS. 1C and 1D are right and left side elevation views, respectively, of the adapter device shown in FIG. 1A.

FIGS. 1E and 1F are top and bottom plan views, respectively, of the adapter device shown in FIG. 1A.

FIGS. 1G and 1H are front and rear elevation views, respectively, of the adapter device shown in FIG. 1A.

FIGS. 2A and 2B are cross sectional views taken along line 2A-2A of FIG. 1E of the adapter device shown in FIG. 1A, wherein FIG. 2B shows a fuel injector received in a fuel injector port of the adapter device.

FIG. 3 is a top plan view of the adapter device shown in FIG. 1A, wherein a plurality of fuel injectors are received in fuel injector ports of the adapter device and attached to a fuel source.

FIG. 4A is a front top perspective view of another embodiment of an adapter device.

FIG. 4B is a front bottom perspective view of the adapter device shown in FIG. 4A.

FIGS. 4C and 4D are right and left side elevation views, respectively, of the adapter device shown in FIG. 4A.

FIGS. 4E and 4F are top and bottom plan views, respectively, of the adapter device shown in FIG. 4A.

FIGS. 4G and 4H are front and rear elevation views, respectively, of the adapter device shown in FIG. 4A.

FIGS. 5A and 5B are cross sectional views taken along line 5A-5A of FIG. 4E of the adapter device shown in FIG. 4A, wherein FIG. 5B shows a fuel injector received in a fuel injector port of the adapter device.

FIG. 6 is a top plan view of the adapter device shown in FIG. 4A, wherein a plurality of fuel injectors are received in fuel injector ports of the adapter device and attached to a fuel source.

FIG. 7A illustrates top and side views of an engine with the upper intake manifold removed.

FIG. 7B illustrates top and side views of the engine shown in FIG. 7A, wherein the adapter device shown in FIG. 6 is installed on the lower intake manifold of the engine.

FIG. 7C illustrates top and side views of the engine shown in FIG. 7B, wherein the upper intake manifold of the engine is installed on the adapter device.

FIG. 8 schematically illustrates an engine according to an embodiment of the present application.

### DESCRIPTION OF EMBODIMENTS

The present application discloses an adapter device and method for converting an engine to operate using a second fuel (e.g., an alternative fuel such as CNG). The adapter device permits placement of one or more second fuel injectors in fluid communication with the intake manifold flow path of the engine without removal of the lower intake manifold. Further, the adapter device facilitates conversion of the engine to operate using a second fuel without removal or disturbance of, or connecting to, the existing fuel injectors of the engine. The existing fuel injectors are undisturbed and remain in their original location after the engine is converted to operate using the second fuel.

In certain embodiments, the adapter device of the present application is described in reference to the conversion of a gasoline engine to operate using a second fuel. However, it should be understood, that the adapter device of the present application may be used to convert various engine types configured to operate using various types of fuel. For example, the adapter device of the present application may be used to convert engines configured to operate using gasoline, diesel, propane, ethanol, or the like.

Further, in certain embodiments, the adapter device of the present application is described as converting an engine to operate using an alternative fuel such as CNG. However, it should be understood, that the adapter device of the present application may be used to convert an engine to operate using various types of fuel. For example, the adapter device of the present application may be used to convert an engine to operate using CNG, Liquid Natural Gas (LNG), Liquid Petroleum Gas (LPG), Hydrogen, Hythane, Butane, or other gaseous fuels and mixtures thereof.

Further, because the adapter device of the present application facilitates conversion of the engine to operate using a second fuel without removal of the original fuel injectors of the engine (e.g., the gasoline fuel injectors), the engine may be configured to selectively operate using the original fuel (e.g., gasoline) and/or the second fuel (e.g., CNG). The original fuel injectors are undisturbed and remain in their original location after the engine is converted to operate using the second fuel.

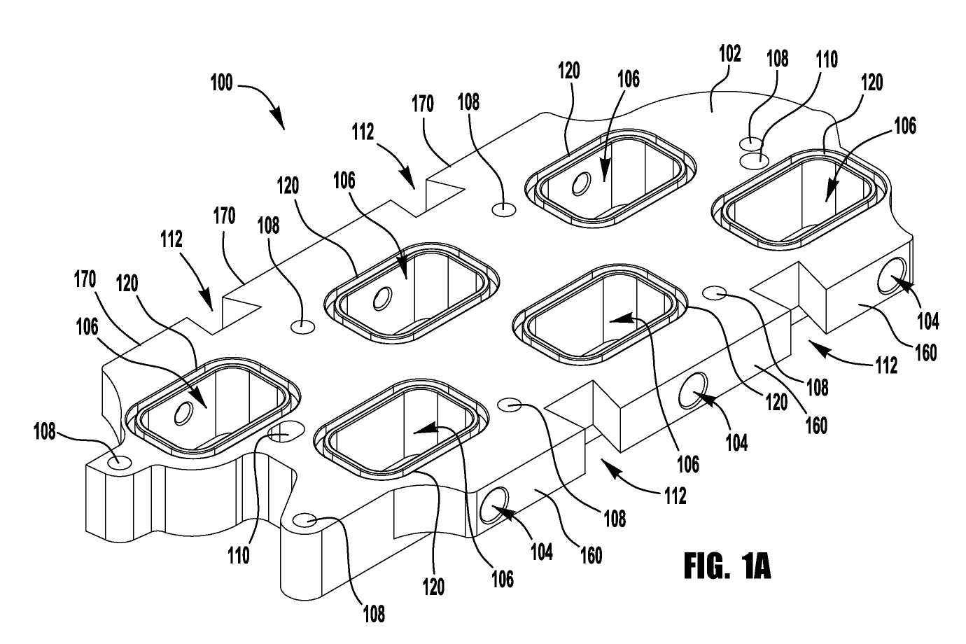

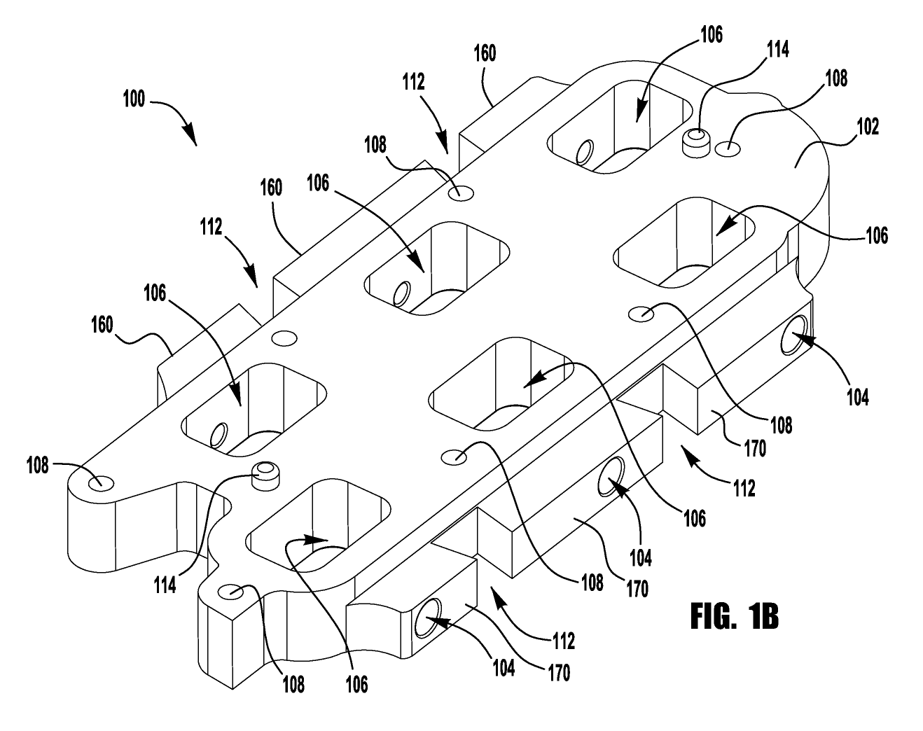

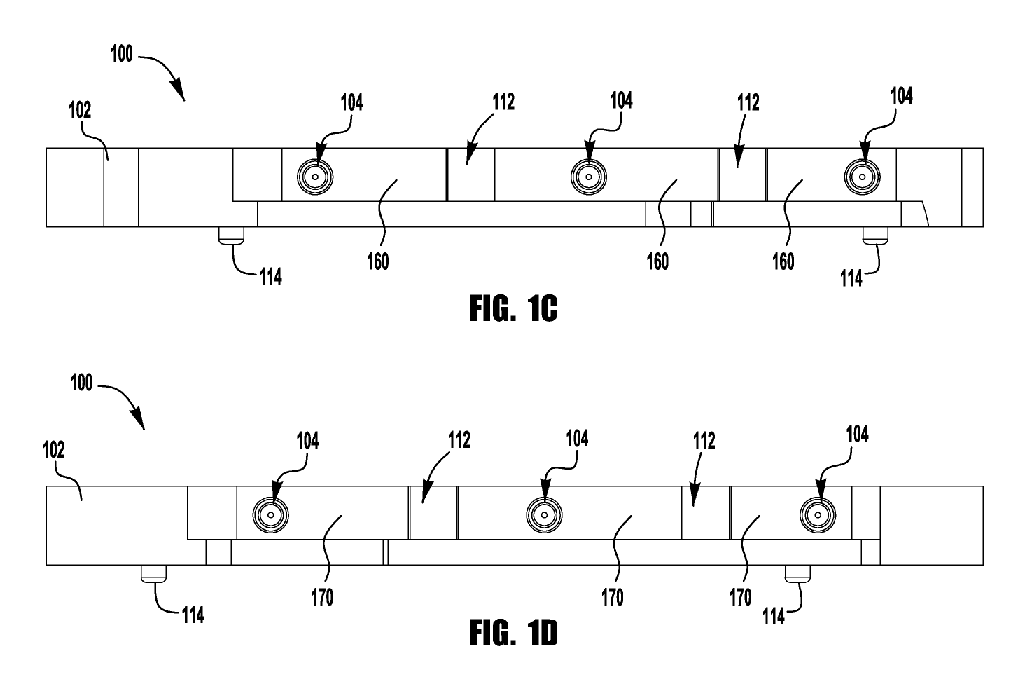

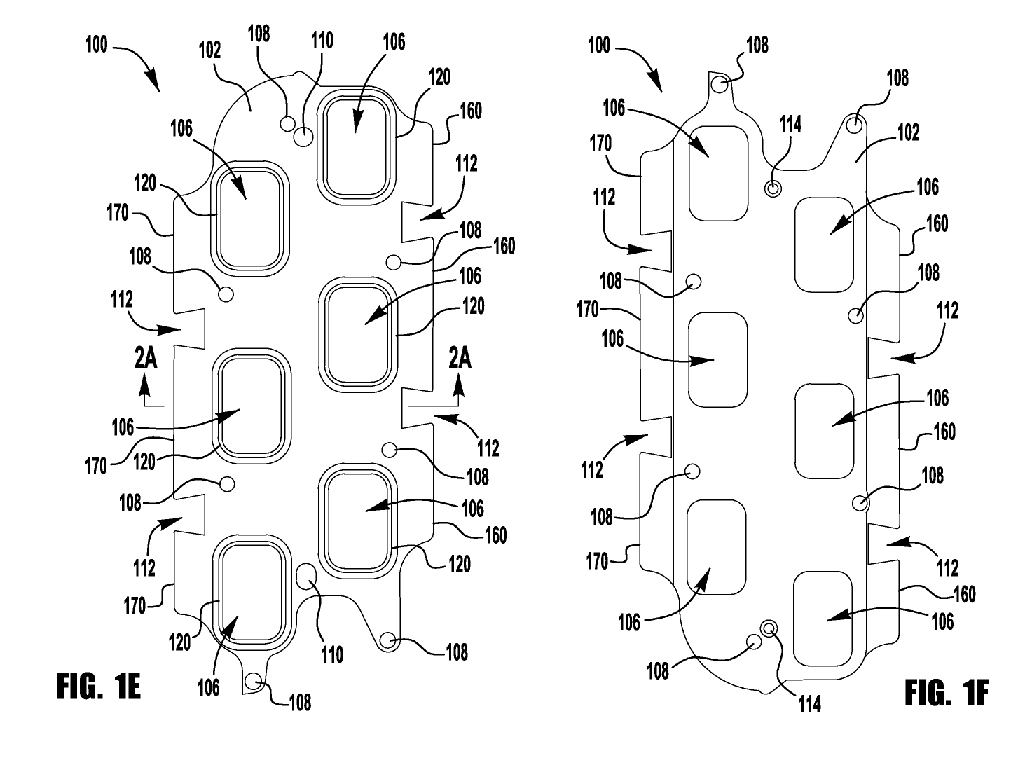

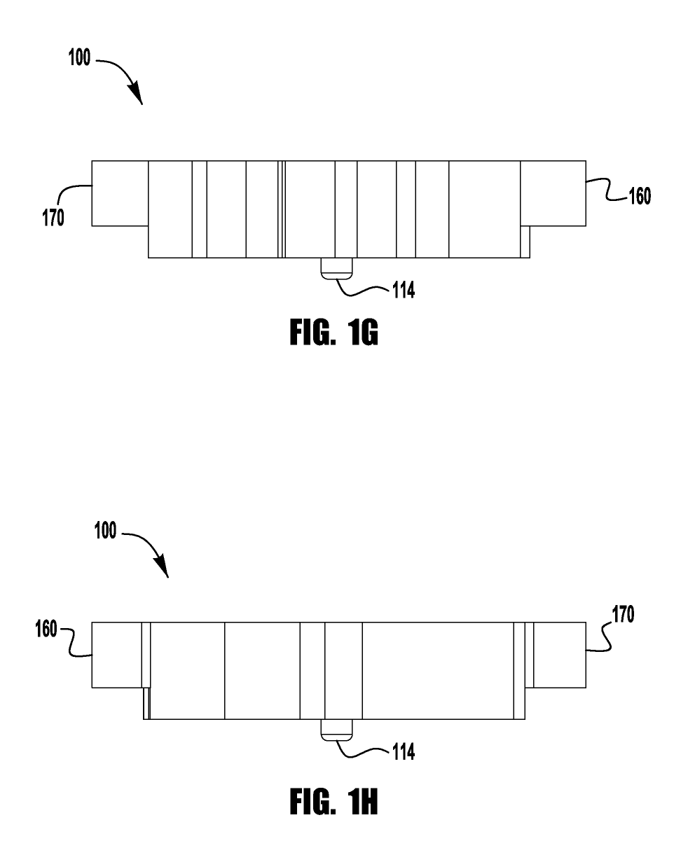

FIGS. 1A-3 illustrate various views of an adapter device 100 according to an embodiment of the present application. As shown, the adapter device 100 includes a body member 102, or plate, having a plurality of intake channels 106, fuel injector ports 104, mounting holes 108, alignment features 110 and 114, and connector portions 112. The adapter device 100 may be fabricated from a variety of materials capable of supporting the upper intake manifold of an engine, a plurality of fuel injectors, and one or more fuel sources (e.g., fuel rails). Exemplary materials include plastic, liquid photopolymers, ferrous materials such as steel or stainless steel, or non-ferrous materials such as aluminum.

The adapter device 100 is sized and configured such that the intake channels 106 mate with the upper and lower intake manifold openings of the engine. Each intake channel 106 is configured to mate with an upper and lower intake manifold opening for a corresponding cylinder of the engine. The adapter device 100 may be configured for use with a variety of engines having any number of cylinders and intake manifold openings, such as, for example, four, six, eight, ten, or twelve cylinder engines.

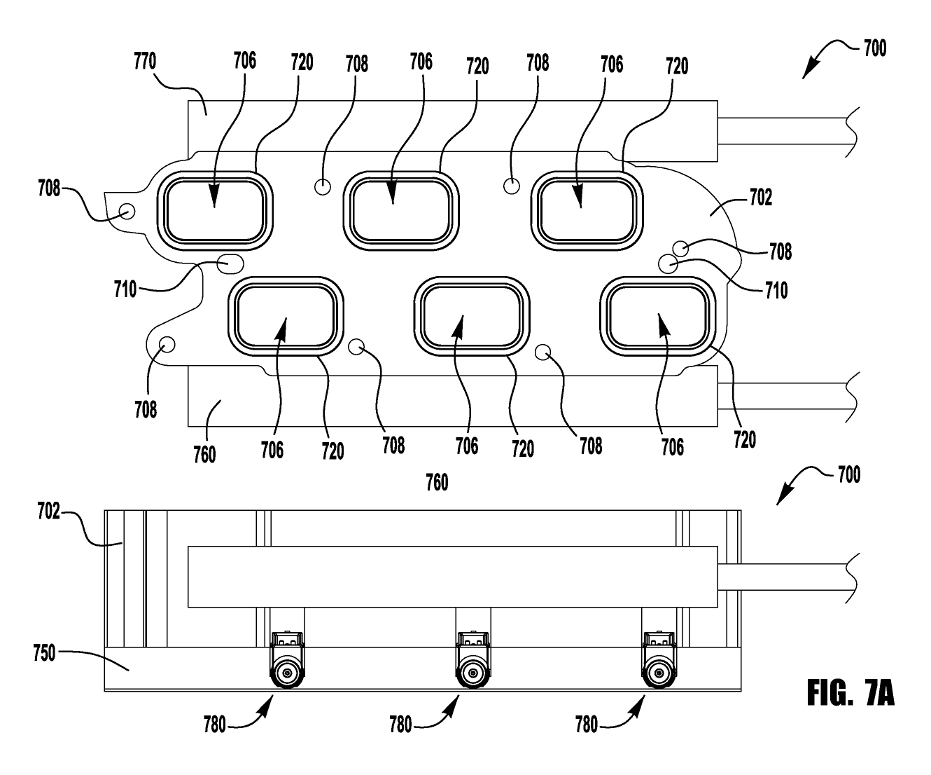

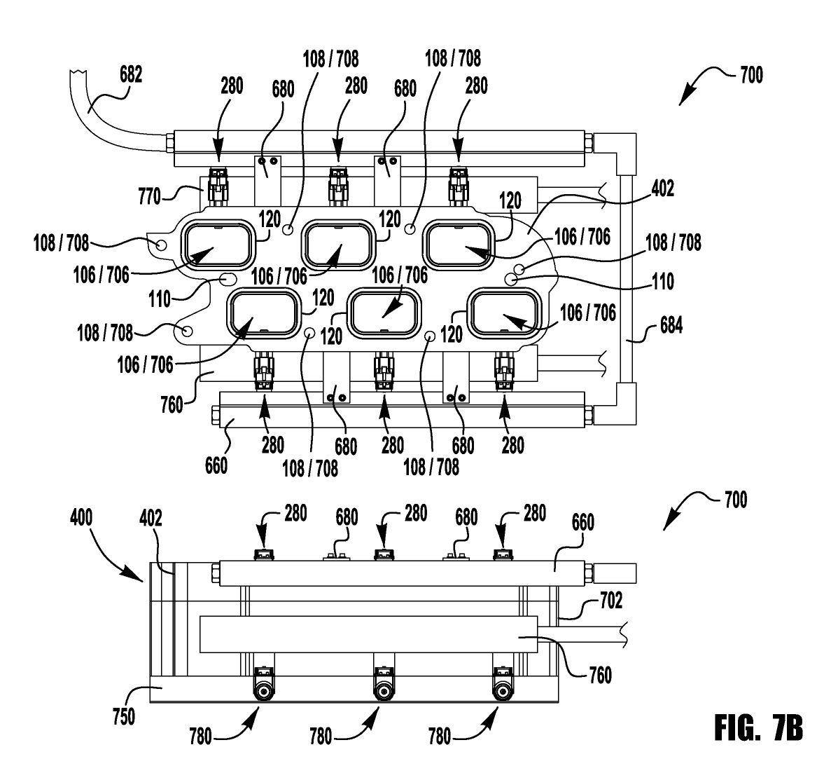

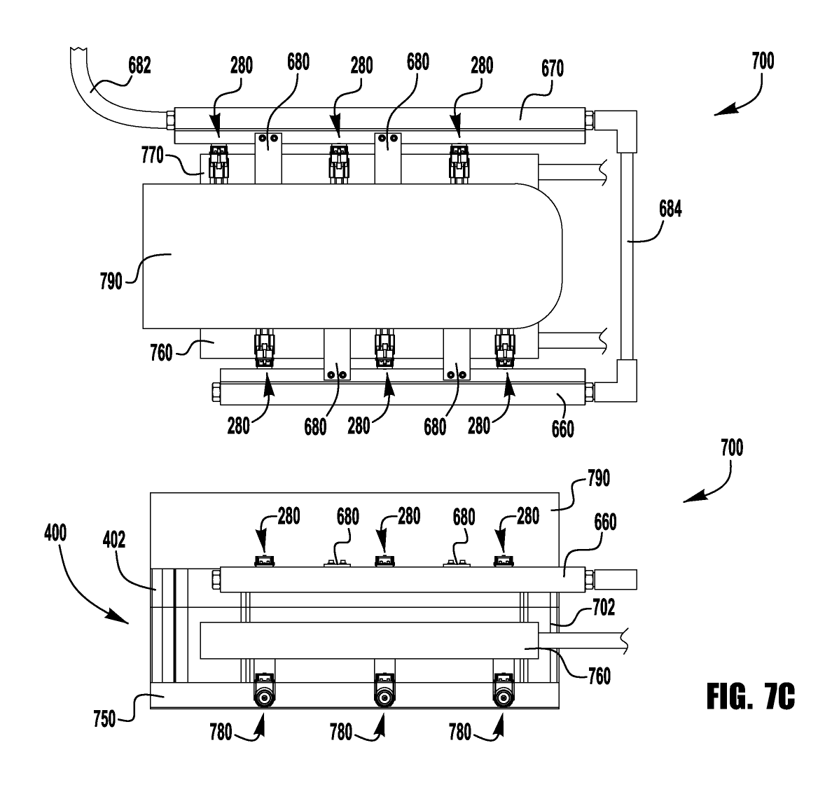

As an example, FIG. 7A illustrates a lower intake manifold 702 of a six cylinder engine 700 with the upper intake manifold removed. Six lower intake manifold openings 706 are shown, one for each cylinder of the engine 700. Each lower intake manifold opening 706 has a seal 720 surrounding the opening, such as, for example, a molded rubber gasket. FIGS. 1B and 1F illustrate the bottom of the adapter device 100. The bottom of each intake channel 106 of the adapter device 100 is sized and configured to mate with a corresponding lower intake manifold opening 706 of the engine 700. The seal 720 of each lower intake manifold opening 706 surrounds the bottom of each intake channel 106 when the adapter device 100 is placed on the lower intake manifold 702 to seal the lower intake manifold opening with the intake channel.

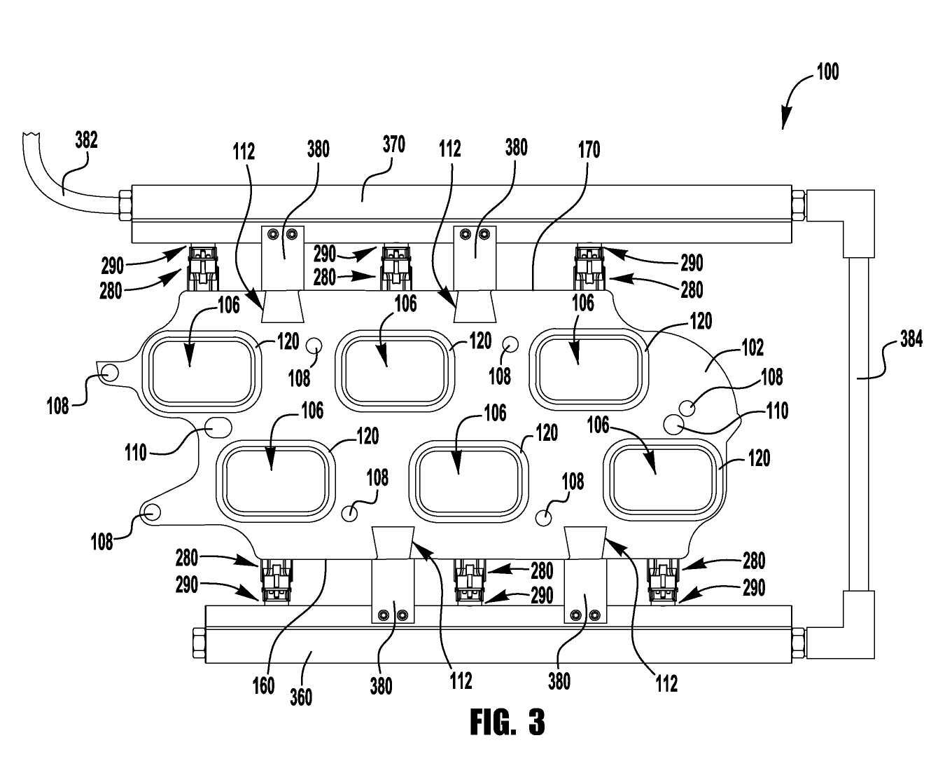

Further, FIGS. 1A, 1E, and 3 illustrate the top of the adapter device 100. The top of each intake channel 106 of the adapter device 100 is sized and configured to mate with a corresponding upper intake manifold opening of the engine 700. The upper intake manifold is installed on top of the adapter device 100 such that the adapter device is positioned between the upper intake manifold and lower intake manifold 702 of the engine 700. As illustrated in FIGS. 1A, 1E, and 3, a sealing cavity 120 surrounds each intake channel 106 of the adapter device 100. A seal, such as a molded rubber gasket, is placed in the sealing cavity 120 to seal the upper intake manifold opening with the intake channel 106 of the adapter device 100. Other methods may be used to seal the lower and/or upper intake manifold openings with the intake channels 106 of the adapter device 100, such as, for example, room temperature vulcanized (RTV) rubber, organic paper gaskets, or ferrous gasket materials.

As shown in FIGS. 1A, 1B, 1E, 1F, and 3, the arrangement of the mounting holes 108 of the adapter device 100 is such that the holes substantially align with the original mounting holes of the upper and lower intake manifold, such as, for example, the mounting holes 708 of the lower intake manifold 702 shown in FIG. 7A. Thus, when the adapter device 100 is placed on the lower intake manifold of the engine, fasteners of the upper intake manifold may be placed through the mounting holes 108 of the adapter device and secured to the lower intake manifold. As such, the adapter device 100 is held in position between the upper and lower intake manifolds of the engine.

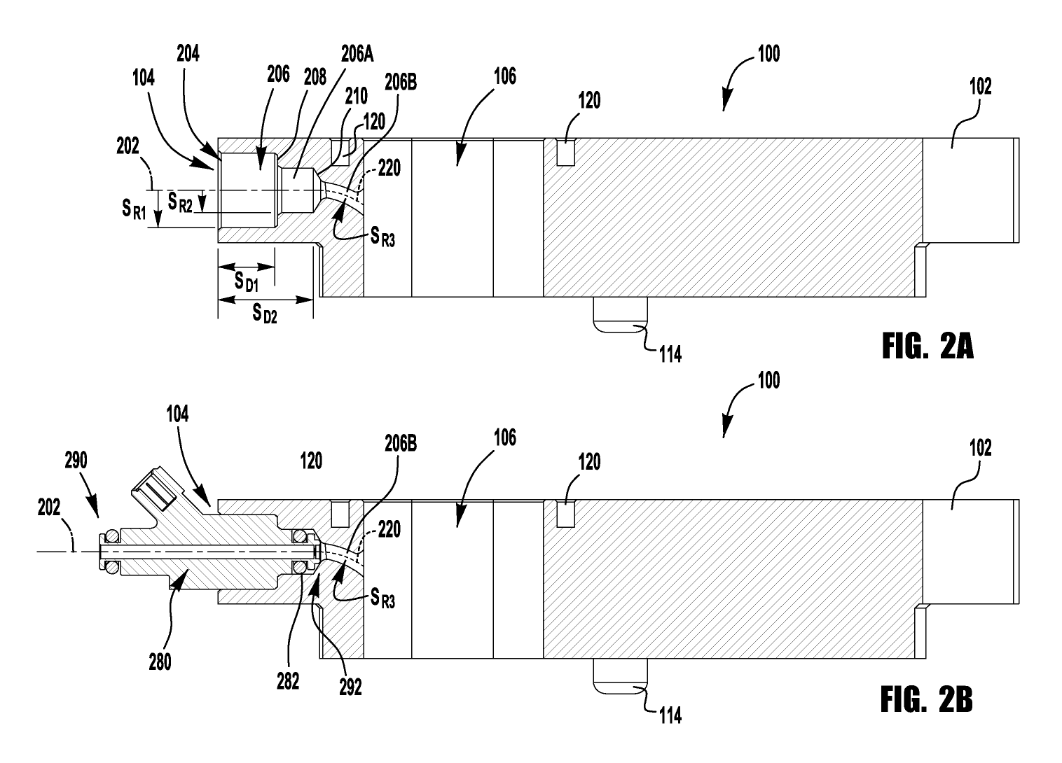

Further, the adapter device 100 is configured with alignment features 110 and 114 that facilitate placement and mounting of the adapter device between the upper and lower intake manifolds of the engine. As illustrated in FIGS. 1A and 1E, the top of the adapter device 100 includes recesses 110, or openings, configured to receive corresponding bosses or protrusions of the upper intake manifold. Further, as illustrated in FIGS. 1B-1D and 1F-2B, the bottom of the adapter device 100 includes bosses 114, or protrusions, configured to mate with corresponding recesses or openings of the lower intake manifold, such as, for example, the recesses or openings 710 of the lower intake manifold 702 shown in FIG. 7A.

The adapter device 100 may be configured as a single unitary component or formed from a combination of components. For example, in one embodiment, the adapter device 100 comprises a plurality of body members, each body member comprising an intake channel and a fuel injector port in fluid communication with the intake channel. Each body member is sized and configured such that the intake channel mates with at least one upper and lower intake manifold opening of the engine. In one embodiment, the adapter device 100 comprises a body member for each cylinder of the engine (e.g., four, six, eight, ten, or twelve cylinders), each body member comprising a single intake channel and a single fuel injector port in fluid communication with the intake channel. The body members are arranged such that the intake channel of each body member mates with an upper and lower intake manifold opening for a cylinder of the engine.

The fuel injector ports 104 formed in the body member 102 of the adapter device 100 extend from a sidewall of the body member to the intake channels 106. For example, as illustrated in FIGS. 1A-1D, three fuel injector ports 104 extend from a first sidewall 160 of the body member 102 to three corresponding intake channels 106 and three fuel injector ports 104 extend from a second sidewall 170 of the body member 102 to three corresponding intake channels 106.

As illustrated in FIG. 2A, each fuel injector port 104 of the adapter device 100 comprises an injector opening 204 and an injector channel 206 formed within the body member 102 of the device. As shown in FIG. 2B, the injector opening 204 and injector channel 206 are shaped and configured to receive a fuel injector 280 for emitting a second fuel into the intake channels 106 of the adapter device 100. In certain embodiments, the fuel injectors 280 are alternative fuel injectors such as a CNG injectors. However, the fuel injector ports 104 may be configured to receive various types of fuel injectors.

The adapter device 100 is also configured such that the fuel injectors 280 are positioned to be connected to one or more fuel sources, such as, for example, a fuel rail or fuel line. For example, FIG. 3 illustrates the fuel injectors 280 installed in the fuel injector ports 104 of the adapter device 100 and positioned to be connected to one or more fuel sources. As shown, the proximal or receiving ends 290 of the fuel injectors 280 are connected to first and second fuel rails 360 and 370 for supplying the second fuel to the fuel injectors. The first and second fuel rails 360 and 370 are attached to opposing sides of the body member 102 with brackets 380. The first and second fuel rails 360 and 370 are supplied with the second fuel via fuel supply line 382 and are fluidly connected together by fuel line 384. In certain embodiments, the second fuel is an alternative fuel such as CNG and the fuel rails are alternative fuel rails such as CNG fuel rails. However, various types of fuel, fuel injectors and fuel sources may be used.

Referring again to FIGS. 2A and 2B, the injector channel 206 of each fuel injector port 104 is in fluid communication with one of the intake channels 106 of the adapter device 100. The fuel injector ports 104 may be configured such that the fuel injector 280 can be selectively positioned relative to the intake channel 106 of the adapter device 100. For example, features of the injector channel 206, such as, for example, one or more stops or ridges in the injector channel, may be configured to position the fuel injector 280 in the injector channel and relative to the intake channel 106 of the adapter device 100.

As illustrated in FIGS. 2A and 2B, the injector opening 204 and a first portion 206A of the injector channel 206 are shaped and configured to receive the fuel injector 280. The first portion 206A of the injector channel 206 comprises a first counterbore 208 and a second counterbore 210. The first counterbore 208 has a depth S_{D1} between about ¼ and ¾ inch, or about ½ inch. The second counterbore 210 has a depth S_{D2} between about ⅜ and 1 inch, or about ¾ inch. The injector opening 204 and the first counterbored portion of the first portion 206A of the injector channel 206 have a radius S_{R1} between about ⅛ and ½ inch, or about ¼ inch. The second counterbored portion of the first portion 206A of the injector channel 206 has a radius S_{R2} between about 1/16 and ½ inch, or about ⅛ inch. Centerline 202 is the centerline of the injector opening 204, the first portion 206A of the injector channel 206, and the fuel injector 280 received in the fuel injector port 104.

As illustrated in FIG. 2B, the circular face formed by the first counterbore 208 and/or the second counterbore 210 may act as a stop to position the fuel injector 280 within the injector channel 206 of the adapter device 100. The first counterbore 208 and/or the second counterbore 210 may be arranged in a variety of ways to position the fuel injector 280 in the injector channel 206 and relative to the intake channel 106 of the adapter device 100.

As illustrated in FIG. 2B, an o-ring 282 provides a seal between the fuel injector 280 and the injector channel 206. However, other methods of sealing the fuel injector 280 with the injector channel 206 are envisioned, such as, for example, with an interference fit, sealant, or threaded connection. Further, the fuel injector ports 104 are sized and configured such that the fuel injectors 280 are held in place within the fuel injector ports by friction or interference fit. However, in other embodiments, other methods of securing the fuel injectors 280 in fluid communication with the fuel injector ports 104 may be used, such as, for example, with a threaded connection, connector, or fitting.

As illustrated in FIG. 2B, the second fuel is emitted from the discharge end 292 of the fuel injector 280 into a second portion 206B of the injector channel 206. The second portion 206B of the injector channel 206 is in fluid communication with the intake channel 106 of the adapter device 100. The second portion 206B of the injector channel 206 is configured to provide a laminar flow of the second fuel, such as gaseous fuel (e.g., CNG), from the fuel injector 280 to the intake channel 106 of the adapter device 100. For example, the second portion 206B of the injector channel 206 is configured such that the flow of CNG from the fuel injector 280 through the second portion has a Reynolds Number less than 10,000, preferably between about 1000 and 9500, and more preferably about 1680. As such, the flow of CNG is considered to be of a laminar or non-turbulent type.

Using the standard Reynolds Number Formula, a straight tube having the same or similar interior diameter as the curved second portion 206B will produce a flow having a Reynolds Number greater than 1900, or about 1950. The threshold for laminar flow of a straight tube with the same or similar interior diameter as the curved second portion 206B is a Reynolds Number of 2100. Accordingly, with a straight tube, coupled with a wide variation in flow/pressure parameters, the laminar flow of the tube is likely to be compromised. In contrast, the curve in the second portion 206B increases the threshold for laminar flow due to the Dean Effect. The curve in the second portion 206B increases the threshold for laminar flow to a Reynolds Number approaching 10,000. Further, changes or fluctuations in various parameters, such as, for example line pressure or tube diameter, may increase or decrease the Reynolds Number. Thus, the curve in the second portion 206B provides a greater margin for the fluctuation of these parameters than the straight tube while still providing laminar flow. Accordingly, the broader range up to 10,000 is beneficial to providing laminar flow in the tube. In one embodiment, the Dean number (De) for the second portion 206B of the injector channel 206 is about 515.

The laminar flow of the second fuel provided by the second portion 206B of the injector channel 206 is important for proper functioning of the engine. In this regard, the laminar flow of fuel results in a more consistent fuel charge delivered to the intake manifold or cylinder head of the engine. As such, accurate metering of the fuel charge from the fuel injector 280 is possible in a short amount of time, e.g., approximately 6 milliseconds or the firing time of the fuel injector.

Alternatively, abrupt angles, sharp turns, or rough surfaces in the flow channel leading from the fuel injector may result in a more turbulent flow of fuel. This is because portions of the flow channel may partially block the outlet of the fuel injector or force the fuel to abruptly change direction. A turbulent flow of fuel results in a less consistent fuel charge delivered to the intake manifold or cylinder head of the engine. An inconsistent fuel charge changes the Stoichiometric mixture of air and fuel and causes the engine to run lean and/or rich. If the engine runs lean and/or rich, emission level requirements at the tailpipe may not be met and/or may cause engine failure. As such, the smooth, laminar flow of fuel provided by the second portion 206B of the injector channel 206 permits the adapter device 100 to meet emission level requirements, such as those outlined in U.S. Environmental Protection Agency standard 40 CFR 86.1801-01 through 40 CFR 86.1815-02.

As illustrated in FIGS. 2A and 2B, the second portion 206B of the injector channel 206 has a smooth surface and a gentle curve resulting in a laminar flow of the second fuel, such as gaseous fuel (e.g., CNG), from the fuel injector 280 to the intake channel 106 of the adapter device 100. The radius of the curvature S_{R3} for the second portion 206B is preferably between about 15 mm and 45 mm, or more preferably about 30 mm. Centerline 220 is the centerline of the second portion 206B of the injector channel 206. The interior diameter of the second portion 206B is preferably between about 1 mm and 4 mm, or more preferably about 3 mm. Further, as illustrated in FIG. 2B, when the fuel injector 280 is installed in the adapter device 100, no portions of the second portion 206B block the outlet at the discharge end of the fuel injector or force the second fuel from the fuel injector to abruptly change direction. Instead, the smooth, gentle curve of the second portion 206B directs the second fuel into the intake channel 106 of the adapter device 100.

As illustrated in FIGS. 1A-1F, the connector portions 112 of the adapter device 100 comprise recesses in the first and second sidewalls 160 and 170 of the body member 102. As shown in FIG. 3, the connector portions 112 facilitate attachment of the first and second fuel rails 360 and 370 for the fuel injectors 280 to the adapter device 100. Brackets 380 attached to the fuel rails 360 and 370 are shaped and configured to mate with the recesses of the connector portions 112. As such, the brackets 380 may be slid into the recesses of the connector portions 112 from the top or bottom. Further, the recesses of the connector portions 112 and the brackets 380 of the fuel rails 360 and 370 are configured such that brackets are prohibited from moving front, back, left, and right relative to the recesses. The brackets 380 may also be held in place in the recesses of the connector portions 112 from the top and bottom by the lower and upper intake manifolds of the engine. Further, the brackets 380 of the fuel rails 360 and 370 may be secured to the body member 102 of the adapter device 100.

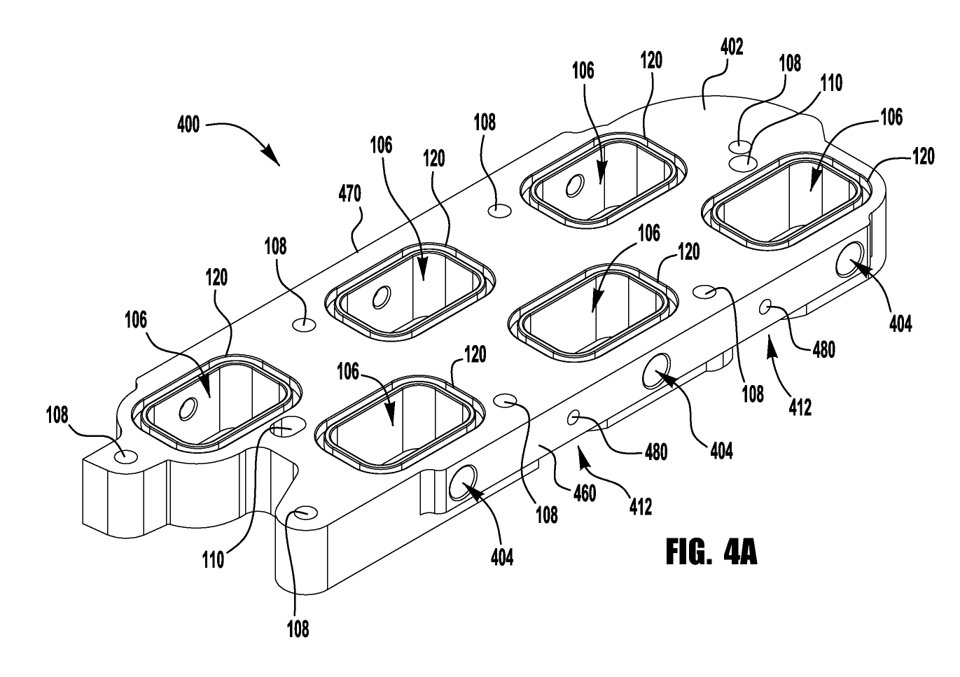

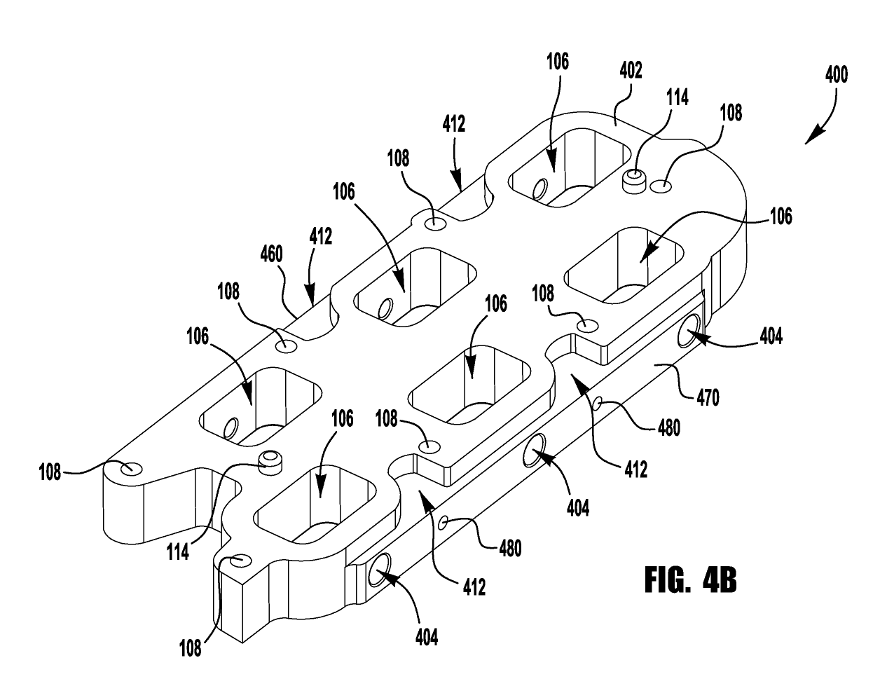

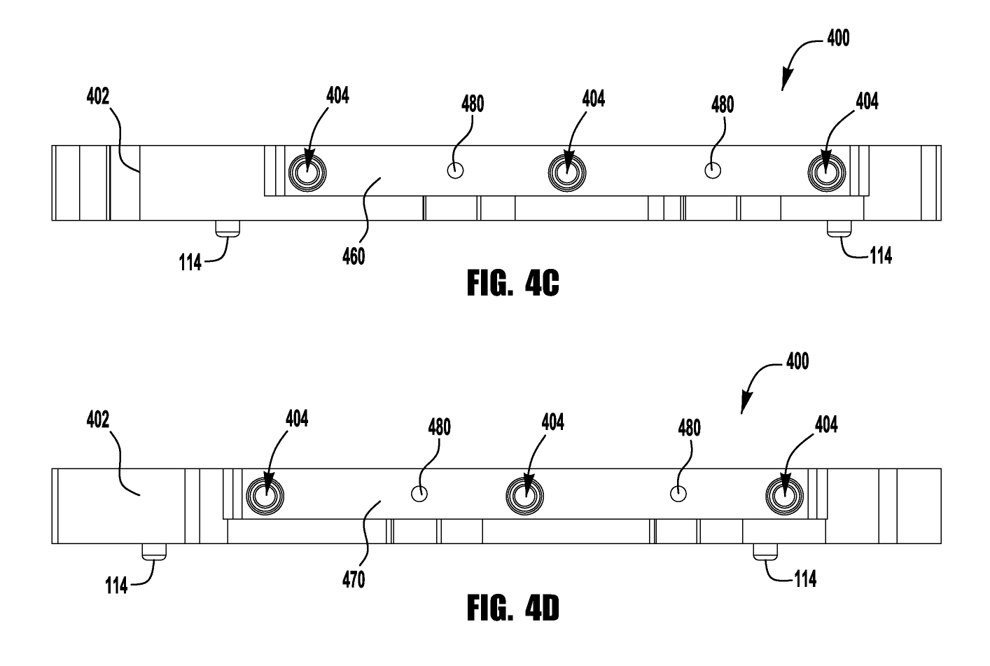

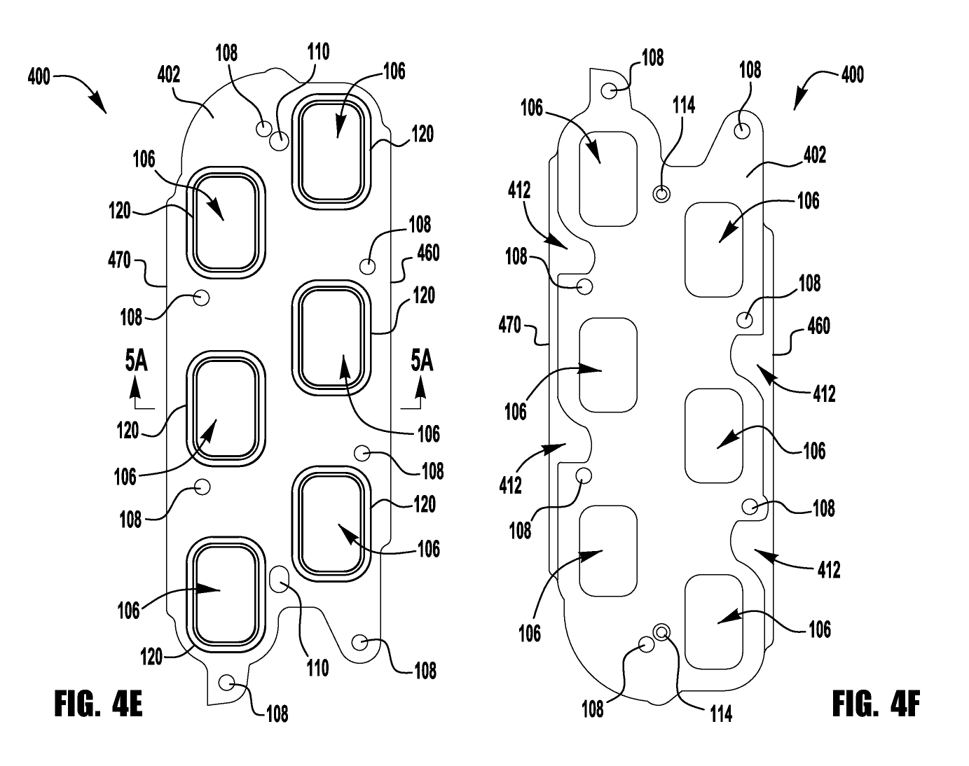

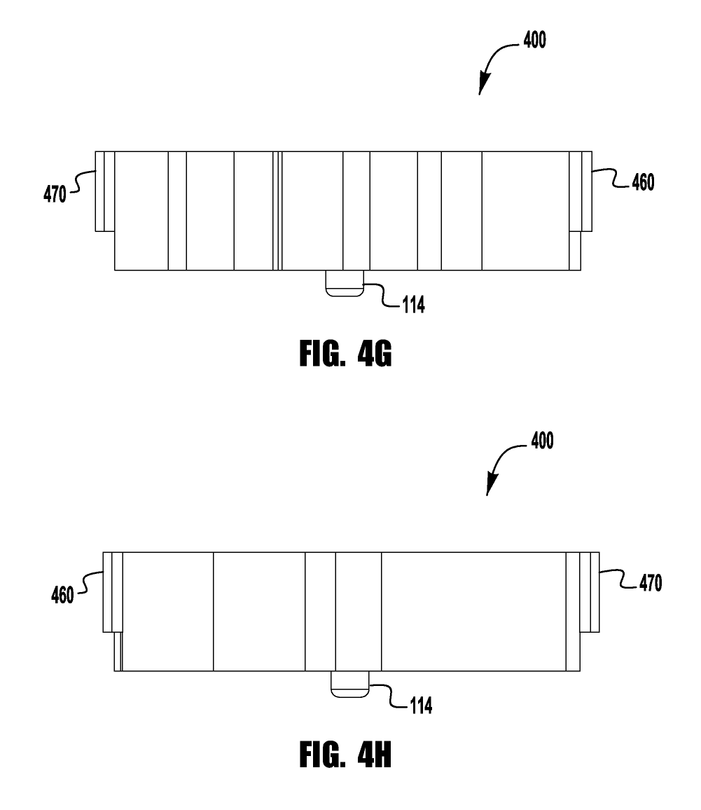

FIGS. 4A-6 illustrate various views of an adapter device 400 according to another embodiment of the present application. As shown, the adapter device 400 includes a body member 402, or plate, having a plurality of intake channels 106 and fuel injector ports 404. The adapter device 400 may be fabricated from a variety of materials capable of supporting the upper intake manifold of an engine, a plurality of fuel injectors, and one or more fuel sources (e.g., fuel rails). Exemplary materials include plastic, liquid photopolymers, ferrous materials such as steel or stainless steel, or non-ferrous materials such as aluminum. In one embodiment, the body member 402 and fuel rails of the adapter device 400 are made of aluminum. Further, the adapter device 400 may be configured for use with a variety of engines having any number of cylinders and intake manifold openings, such as, for example, four, six, eight, ten, or twelve cylinder engines.

Similar to the adapter device 100 shown in FIGS. 1A-3 and described above, the adapter device 400 is sized and configured such that the intake channels 106 mate with the upper and lower intake manifold openings of the engine. For example, The bottom of each intake channel 106 of the adapter device 400 is sized and configured to mate with a corresponding lower intake manifold opening of the engine. The seal of each lower intake manifold opening surrounds the bottom of each intake channel 106 when the adapter device 400 is placed on the lower intake manifold to seal the lower intake manifold opening with the intake channel. Further, The top of each intake channel 106 of the adapter device 400 is sized and configured to mate with a corresponding upper intake manifold opening of the engine. A sealing cavity 120 surrounds each intake channel 106 of the adapter device 400. A seal is placed in the sealing cavity 120 to seal the upper intake manifold opening with the intake channel 106 of the adapter device 400.

Further, the arrangement of mounting holes 108 of the adapter device 400 are similar to those of adapter device 100. For example, the arrangement of the mounting holes 108 of the adapter device 400 is such that the holes substantially align with the original mounting holes of the upper and lower intake manifold. Thus, when the adapter device 400 is placed on the lower intake manifold of the engine, fasteners of the upper intake manifold may be placed through the mounting holes 108 of the adapter device and secured to the lower intake manifold. As such, the adapter device 400 is held in position between the upper and lower intake manifolds of the engine.

The alignment features 110 and 114 of the adapter device 400 are also similar to those of adapter device 100. The top of the adapter device 400 includes recesses 110, or openings, configured to receive corresponding bosses or protrusions of the upper intake manifold. Further, the bottom of the adapter device 400 includes bosses 114, or protrusions, configured to mate with corresponding recesses or openings of the lower intake manifold.

The fuel injector ports 404 formed in the body member 402 of the adapter device 400 extend from a sidewall of the body member to the intake channels 106. For example, as illustrated in FIGS. 4A-4D, three fuel injector ports 404 extend from a first sidewall 460 of the body member 402 to three corresponding intake channels 406 and three fuel injector ports 404 extend from a second sidewall 470 of the body member 402 to three corresponding intake channels 106.

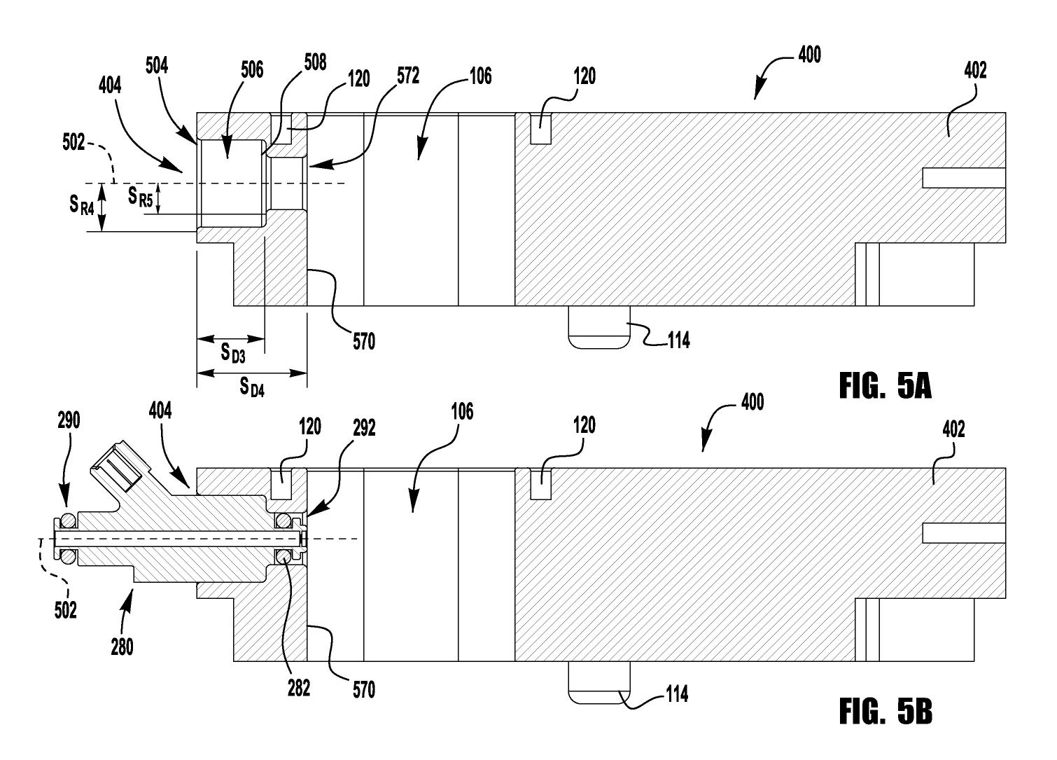

As illustrated in FIG. 5A, each fuel injector port 404 of the adapter device 400 comprises an injector opening 504 and an injector channel 506 formed within the body member 402 of the device. As shown in FIG. 5B, the injector opening 504 and injector channel 506 are shaped and configured to receive a fuel injector 280 for emitting a second fuel directly into the intake channels 106 of the adapter device 400. In certain embodiments, the fuel injectors 280 are alternative fuel injectors such as a CNG injectors. However, the fuel injector ports 404 may be configured to receive various types of fuel injectors.

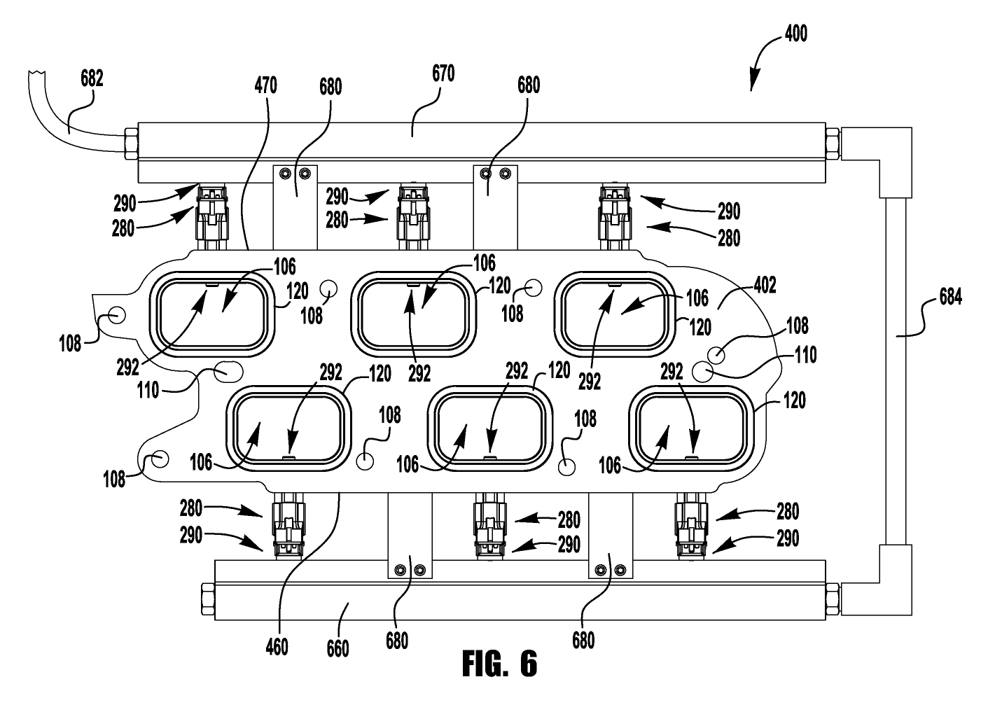

The adapter device 400 is also configured such that the fuel injectors 280 are positioned to be connected to one or more fuel sources, such as, for example, a fuel rail or fuel line. For example, FIG. 6 illustrates the fuel injectors 280 installed in the fuel injector ports 404 of the adapter device 400 and positioned to be connected to one or more fuel sources. As shown, the proximal or receiving ends 290 of the fuel injectors 280 are connected to first and second fuel rails 660 and 670 for supplying the second fuel to the fuel injectors. The first and second fuel rails 660 and 670 are attached to opposing sides of the body member 402 with brackets 680. The first and second fuel rails 660 and 670 are supplied with the second fuel via fuel supply line 682 and are fluidly connected together by fuel line 684. In certain embodiments, the second fuel is an alternative fuel such as CNG and the fuel rails are alternative fuel rails such as CNG fuel rails. However, various types of fuel, fuel injectors and fuel sources may be used.

Referring again to FIGS. 5A and 5B, the injector channel 506 of each fuel injector port 404 is in fluid communication with one of the intake channels 106 of the adapter device 400. As shown, the injector channel 506 is configured such that the discharge end 292 of the fuel injector 280 emits the second fuel directly into the intake channel 106. Positioning the discharge end 292 of the fuel injector 280 such that the second fuel is emitted directly into the intake channel 106 results in a similar charge of fuel being delivered to the cylinder valve as if the fuel injector was mounted directly in the intake manifold of the engine. Further, the absence of a passage between the discharge end 292 of the fuel injector 280 and the intake channel 106 eliminates the risk of turbulent flow occurring between the fuel injector and the intake channel.

The fuel injector ports 404 may be configured such that the fuel injector 280 can be selectively positioned relative to the intake channel 106 of the adapter device 400. For example, features of the injector channel 506, such as, for example, one or more stops or ridges in the injector channel, may be configured to position the fuel injector 280 in the injector channel and relative to the intake channel 106 of the adapter device 400.

As illustrated in FIGS. 5A and 5B, the injector opening 504 and the injector channel 506 are shaped and configured to receive the fuel injector 280. The injector channel 506 comprises a counterbore 508. In certain embodiments, the counterbore 508 has a depth S_{D3} between about ¼ and ¾ inch, between about 0.2 and 0.7 inch, about 0.4 inch, or about 0.425 inch. Further, in certain embodiments, the overall depth S_{D4} of the fuel injector port 404, or the length of the injector channel 506 between the injector opening 504 and the outlet 572 into the intake channel 106, is between about ½ and 1¼ inches, between about ¾ and 1 inch, between about 0.7 and 1.0 inch, between about 0.78 and 0.93 inch, about 0.79 inch, or about 0.93 inch. The overall depth S_{D4} of the fuel injector port 404 and/or the depth S_{D3} of the counterbore 508 may vary between fuel injector ports of the adapter device.

The injector opening 504 and the injector channel 506 may be configured to receive a variety of shapes and sizes of fuel injectors, such as, for example, fuel injectors having a diameter of 11 mm, 14 mm, or greater. In certain embodiments, the injector opening 504 and the counterbored portion of the injector channel 506 have a radius S_{R4} between about ⅛ and ½ inch, between about 0.2 and 0.4 inch, about ¼ inch, about 0.3 inch, about 0.27 inch, between about 4 and 10 mm, between about 5 and 8 mm, or about 7 mm. The outlet 572 of the injector channel 506 has a radius S_{R5} between about 1/16 and ½ inch, between about 0.1 and 0.3 inch, about ⅛ inch, or about 0.2 inch. Centerline 502 is the centerline of the injector opening 504, the injector channel 506, the outlet 572, and the fuel injector 280 received in the fuel injector port 404.

As illustrated in FIG. 5B, the circular face formed by the counterbore 508 acts as a stop to position the fuel injector 280 within the injector channel 506 of the adapter device 400. The counterbore 508 may be arranged in a variety of ways to position the fuel injector 280 in the injector channel 506 and relative to the intake channel 106 of the adapter device 400. For example, the depth S_{D3} of the counterbore 508 may be increased or decreased to position the fuel injector 280 within the injector channel 506 and relative to the intake channel 106. Further, in certain embodiments, an o-ring may be used to position the fuel injector 280 in the injector channel 508 and relative to the intake channel 106 of the adapter device 400.

The fuel injector port 404 may be configured to position the discharge end 292 of the fuel injector 280 (i.e., the end of the fuel injector emitting the second fuel) such that it is substantially flush with a wall of the intake channel 106 or inside the intake channel. As such, the second fuel is emitted directly into the intake channel 106 and does not travel through a passage of the adapter device 400 before entering the intake channel. For example, as illustrated in FIG. 5B, the fuel injector port 404 is configured such that the discharge end 292 of the fuel injector 280 is substantially flush with a wall 570 of the intake channel 106. Further, as shown in FIG. 6, the fuel injector port 404 is configured such that the discharge ends 292 of the fuel injectors 280 are inside the intake channels 106.

As illustrated in FIG. 5B, an o-ring 282 provides a seal between the fuel injector 280 and the injector channel 506. However, other methods of sealing the fuel injector 280 with the injector channel 506 are envisioned, such as, for example, with an interference fit, sealant, or threaded connection. Further, the fuel injector ports 404 are sized and configured such that the fuel injectors 280 are held in place within the fuel injector ports by friction or interference fit. However, in other embodiments, other methods of securing the fuel injectors 280 in fluid communication with the fuel injector ports 404 may be used, such as, for example, with a threaded connection, connector, or fitting.

The adapter device 400 may comprise features that facilitate mounting of one or more fuel sources to the body member 402. For example, as illustrated in FIGS. 4A-4D, the first and second sidewalls 460 and 470 of the body member 402 comprise openings 480 that may be used to receive a fastener (e.g., a threaded fastener) to attach the brackets 680 for the first and second fuel rails 660 and 670 to the body member. Further, as illustrated in FIGS. 4B and 4F, the adapter device 400 comprises recessed portions 412 on the bottom of the body member 402. In certain embodiments, the brackets 680 comprise a flanged portion that is received in these recessed portions 412 of the body member 402. As such, downward forces applied on the first and second fuel rails 660 and 670 press the flanged portion of the brackets 680 against the body member 402 to reduce the amount of stress on the fasteners received in the openings 480, such as, for example, to prohibit the fasteners from being stripped or pulled out of the openings.

The adapter devices 100 and 400 of the present application facilitate the conversion of a gasoline engine to operate using CNG. The adapter devices 100 and 400 may be described as a “plug and play” system. In other words, the adapter devices 100 and 400 permit the gasoline engine to be converted to operate using CNG without complete removal of the lower intake manifold or cylinder head to install the CNG fuel injectors. Thus, the time required to complete the conversion, as well as the cost of the conversion, is reduced by use of the adapter devices 100 and 400.

One exemplary method of installing the adapter devices of the present application is described below. Although the method is described with occasional reference to the adapter device 400, the method may be used to install any of the adapter devices of the present application.

The exemplary method includes inserting the fuel injectors 280 into the fuel injector ports 404 of the adapter device 400. The fuel injectors 280 are configured to emit the second fuel into the intake channels 106 of the adapter device 400. The fuel injectors 280 are selectively positioned within the injector channels 506 of the fuel injector ports 404. The counterbore 508 of the injector channel 506 may be used to facilitate positioning of the fuel injector 280 within the injector channel and relative to the intake channel 106 of the adapter device 400.

One or more fuel sources may be connected to the fuel injectors 280. For example, the first and second fuel rails 660 and 670 may be connected to the fuel injectors 280 before or after the fuel injectors are inserted into the fuel injector ports 404. The fuel rails 660 and 670 may also be attached to the adapter device 400. For example, the brackets 680 may be attached to the fuel rails 660 and 670 and the body member 402 of the adapter device 400.

The exemplary method includes removing the upper intake manifold of the engine. FIG. 7A illustrates an exemplary lower intake manifold 702 of the engine 700 with the upper intake manifold removed. The existing fuel sources 760 and 770 and existing fuel injectors 780 of the engine 700 are illustrated in FIG. 7A. As shown, the existing fuel injectors 780 are positioned to emit the first fuel into an intake port or cylinder head 750 of the engine 700.

As illustrated in FIG. 7B, the adapter device 400 is installed on the lower intake manifold 702 of the engine 700. The intake channels 106 of the adapter device 400 are aligned with the lower intake manifold openings 706. This alignment may be facilitated by use of bosses or protrusions 114 on the bottom of the adapter device 400 that are configured to mate with corresponding recesses or openings 710 of the lower intake manifold 702. The fuel injectors 280 may be installed in the injector ports 404 of the adapter device 400 before or after installation of the adapter device on the lower intake manifold 702. Further, the fuel injectors 280 may be connected to the fuel rails 660 and 670 and the fuel rails may be attached to the body member 402 of the adapter device 400 before or after installation of the device on the lower intake manifold 702.

As illustrated in FIG. 7C, the upper intake manifold 790 of the engine 700 is installed on the adapter device 400. The upper intake manifold openings are aligned with the intake channels 106 of the adapter device 400. This alignment may be facilitated by use of recesses or openings 110 on the top of the adapter device 400 that are configured to receive corresponding bosses or protrusions of the upper intake manifold 790. Fasteners, such as bolts, of the upper intake manifold 790 are placed through the mounting holes 108 of the adapter device 400 and secured to the lower intake manifold 702. As such, the adapter device 400 is held in position between the upper intake manifold 790 and the lower intake manifold 702 of the engine 700. The fuel injectors 280 may be connected to the electrical components of the vehicle before or after the upper intake manifold 790 is installed on the adapter device 400.

As illustrated in FIGS. 7A-7C, the adapter device 400 permits placement of the fuel injectors 280 in fluid communication with the intake manifold flow path of the engine 700 without removal of the lower intake manifold 702. Further, the adapter device 400 facilitates conversion of the engine 700 to operate using a second fuel without removal of or connection to the existing fuel injectors 780 of the engine. The existing fuel injectors 780 are undisturbed and remain in their original location after the engine 700 is converted to operate using the second fuel. As such, the engine 700 may selectively operate using the first fuel and the second fuel. In one embodiment, the first fuel is gasoline fuel, the second fuel is compressed natural gas fuel, the fuel injectors 780 are gasoline fuel injectors, and the fuel injectors 280 are compressed natural gas fuel injectors.

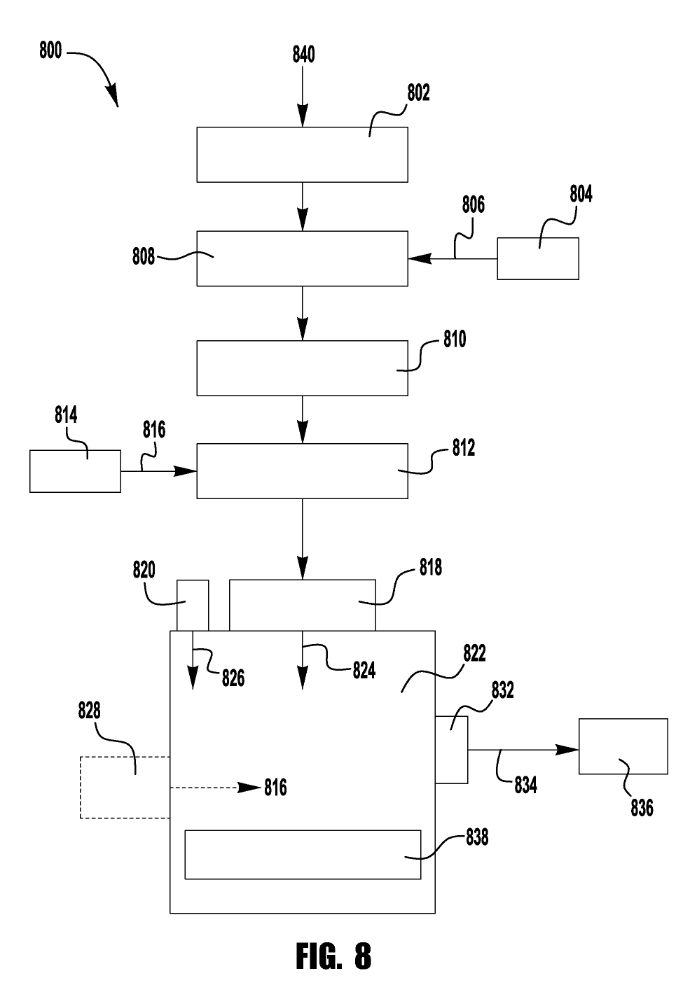

FIG. 8 schematically illustrates an internal combustion engine 800 configured to selectively operate using a first fuel (e.g., gasoline fuel) and a second fuel (e.g., compressed natural gas). As shown, air 840 is received in the upper intake manifold 802 of the engine 800. The air 840 passes from the upper intake manifold 802 through an intake channel of an adapter device 808 of the present application (e.g., adapter device 100 or 400). At this point, if the second fuel is selected for use, the air 840 is mixed with a second fuel 806 inside the intake channel of the adapter device 808 to form mixture 824. The second fuel 806 is emitted from a second fuel injector 804 into the intake channel of the adapter device 808. The mixture 824 passes through the lower intake manifold 810, the intake port or cylinder head 812, and the inlet valve 818 to a combustion chamber 822 of the cylinder. In the combustion chamber 822, the mixture 824 is ignited using a spark 826 from a spark plug 820 of the engine 800 to move a piston 838 of the cylinder. The exhaust 834 is emitted from the combustion chamber 822 through an outlet valve 834 to an exhaust manifold 836.

When the first fuel is selected to operate the engine 800, the air 840 passes through the intake channel of the adapter device 808 but is not mixed with the second fuel 806 in the intake channel. Instead, the air 840 is mixed with a first fuel 816 in the intake port or cylinder head 812 of the engine 800 to form mixture 824. The first fuel 816 is emitted from a first fuel injector 814 into the intake port or cylinder head 812 of the engine 800. The mixture 824 passes through the inlet valve 818 to the combustion chamber 822 of the cylinder. In the combustion chamber 822, the mixture 824 is ignited using a spark 826 from a spark plug 820 of the engine 800 to move a piston 838 of the cylinder. The exhaust 834 is emitted from the combustion chamber 822 through an outlet valve 834 to an exhaust manifold 836. Alternatively, when the first fuel is selected to operate the engine 800, the air 840 may be mixed with the first fuel 816 within the combustion chamber 822 of the cylinder. In this embodiment, the first fuel 816 is emitted from a first fuel injector 816 directly into the combustion chamber 822 of the cylinder.

As illustrated in FIG. 8, the adapter device 808 positions the second fuel injector 804 such that the second fuel 806 is emitted into the intake manifold flow path or airflow path of the engine 800 at a location that is upstream from the first fuel injectors 814 and 828. In one embodiment, the first fuel 816 is gasoline fuel, the second fuel 806 is compressed natural gas fuel, the first fuel injectors 814 and 828 are gasoline fuel injectors, and the second fuel injector 804 is a compressed natural gas fuel injector.

As described herein, when one or more components are described as being connected, joined, affixed, coupled, attached, or otherwise interconnected, such interconnection may be direct as between the components or may be in direct such as through the use of one or more intermediary components. Also as described herein, reference to a “member,” “component,” or “portion” shall not be limited to a single structural member, component, or element but can include an assembly of components, members or elements.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. For example, where components are releasably or removably connected or attached together, any type of releasable connection may be suitable including for example, locking connections, fastened connections, tongue and groove connections, etc. Still further, component geometries, shapes, and dimensions can be modified without changing the overall role or function of the components. The adapter device of the present application may be configured with more or less fuel injector ports and intake channels. For example, the adapter device of the present application may include four, eight, ten, or twelve fuel injector ports and intake channels. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. An adapter device for converting an internal combustion engine to operate using a second fuel, the adapter device comprising:
a body member configured to be installed between an upper intake manifold and a lower intake manifold of the engine, wherein a top of the body member is configured to mate with the upper intake manifold and a bottom of the body member is configured to mate with the lower intake manifold;
a plurality of intake channels formed in the body member, wherein each intake channel extends through the body member from the top to the bottom, and wherein the body member is configured such that each intake channel is substantially aligned with corresponding intake openings of the upper and lower intake manifolds when the body member is installed between the upper and lower intake manifolds; and
a plurality of fuel injector ports formed in the body member, each fuel injector port extending from a sidewall of the body member to at least one intake channel, wherein each fuel injector port is configured to receive a fuel injector for emitting the second fuel and position a discharge end of the fuel injector such that the second fuel is emitted directly into the at least one intake channel.

2. The adapter device of claim 1, wherein each fuel injector port is configured to position the discharge end of the fuel injector inside the at least one intake channel.

3. The adapter device of claim 1, wherein each fuel injector port is configured to position the discharge end of the fuel injector such that it is substantially flush with a wall of the at least one intake channel.

4. The adapter device of claim 1 further comprising at least one fuel source attached to the body member and configured to supply the second fuel to the fuel injectors received in the fuel injector ports of the body member.

5. The adapter device of claim 4, wherein the at least one fuel source comprises a first fuel rail and a second fuel rail, and wherein the first and second fuel rails are attached to opposing sides of the body member, and wherein each of the first and second fuel rails are attached to the body member with one or more brackets.

6. The adapter device of claim 4, wherein the adapter device is configured such that it can be installed between the upper and lower intake manifolds without removal of existing fuel components that permit the engine to operate using a first fuel.

7. The adapter device of the claim 6, wherein installation of the adapter device permits the engine to selectively operate using the first fuel and the second fuel.

8. The adapter device of claim 7, wherein the first fuel is gasoline fuel and the second fuel is compressed natural gas fuel, and wherein the fuel injectors received in the fuel injector ports of the body member are compressed natural gas fuel injectors.

9. The adapter device of claim 1, wherein the fuel injector ports extend from a first sidewall and a second sidewall of the body member, and wherein the first and second sidewalls are located on opposing sides of the body member.

10. The adapter device of claim 1, wherein the body member is configured such that each intake channel is substantially sealed with the corresponding intake openings of the upper and lower intake manifolds when the body member is installed between the upper and lower intake manifolds.

11. The adapter device of claim 10, wherein each intake channel is configured to mate with a corresponding lower intake manifold opening, and wherein a seal of each lower intake manifold opening substantially surrounds each intake channel to seal the lower intake manifold opening with the intake channel when the body member is installed between the upper and lower intake manifolds.

12. The adapter device of claim 11, wherein each intake channel is configured to mate with a corresponding upper intake manifold opening, and wherein a sealing cavity substantially surrounds each intake channel, and wherein a seal is disposed within each sealing cavity to seal the intake channel with the upper intake manifold opening when the body member is installed between the upper and lower intake manifolds.

13. The adapter device of claim 1, wherein the body member comprises one or more mounting holes that substantially align with one or more existing mounting holes of the upper and lower intake manifolds when the body member is installed between the upper and lower intake manifolds.

14. The adapter device of claim 1, wherein the body member comprises one or more alignment features that facilitate installation of the body member between the upper and lower intake manifolds of the engine.

15. The adapter device of claim 14, wherein the one or more alignment features comprise at least one of a recess in the top of the body member and a protrusion extending from the bottom of the body member.

16. The adapter device of claim 1, wherein the body member comprises aluminum.

17. An adapter device for converting an internal combustion engine to operate using a second fuel, the adapter device comprising:
a body member configured to be installed between an upper intake manifold and a lower intake manifold of the engine, wherein a top of the body member is configured to mate with the upper intake manifold and a bottom of the body member is configured to mate with the lower intake manifold;
a plurality of intake channels formed in the body member, wherein each intake channel extends through the body member from the top to the bottom, and wherein the body member is configured such that each intake channel is substantially aligned with corresponding intake openings of the upper and lower intake manifolds when the body member is installed between the upper and lower intake manifolds; and
a plurality of fuel injector ports formed in the body member, each fuel injector port extending from a sidewall of the body member to at least one intake channel, wherein each fuel injector port is configured to receive a fuel injector for emitting the second fuel and position a discharge end of the fuel injector such that the second fuel is emitted into an injector channel of the fuel injector port that is in fluid communication with the at least one intake channel, and wherein the injector channel of each fuel injector port is curved to provide a laminar flow of the second fuel through the injector channel and into the at least one intake channel.

18. The adapter device of claim 17, wherein the fuel injectors are compressed natural gas fuel injectors configured to emit compressed natural gas fuel, and wherein the flow of the compressed natural gas fuel through the injector channel of each fuel injector port has a Reynolds Number between about 1000 and 9500.

19. The adapter device of claim 17, wherein no portion of the injector channel at least partially blocks an outlet of the fuel injector.

20. The adapter device of claim 17, wherein no portion of the injector channel causes the second fuel emitted from the fuel injector to abruptly change direction.

21. The adapter device of claim 17, wherein the injector channel is free of abrupt angles and sharp turns such that the second fuel emitted from the fuel injector does not abruptly change direction.

22. The adapter device of claim 17, wherein the radius of curvature of the injector channel is between about 15 mm and 45 mm.

23. The adapter device of claim 22, wherein the radius of curvature of the injector channel is about 30 mm.

24. The adapter device of claim 17, wherein the diameter of the injector channel is between about 1 mm and 4 mm.

25. The adapter device of claim 24, wherein the diameter of the injector channel is about 3 mm.

26. An internal combustion engine configured to selectively operate using a first fuel and a second fuel, the engine comprising:
an upper intake manifold having a plurality of upper intake manifold openings;
a lower intake manifold having a plurality of lower intake manifold openings;
an adapter device positioned between the upper and lower intake manifolds, the adapter device comprising:
a body member having a top that mates with the upper intake manifold and a bottom that mates with the lower intake manifold;
a plurality of intake channels formed in the body member, wherein each intake channel extends through the body member from the top to the bottom, and wherein each intake channel is substantially aligned with at least one lower intake manifold opening and at least one upper intake manifold opening; and
a plurality of fuel injector ports formed in the body member, each fuel injector port extending from a sidewall of the body member to at least one intake channel; and
a plurality of second fuel injectors for emitting the second fuel, wherein each second fuel injector is received in one of the fuel injector ports of the adapter device, and wherein each second fuel injector is positioned within the fuel injector port such that the second fuel is emitted directly into the at least one intake channel of the adapter device.

27. The engine of claim 26, wherein each second fuel injector port is positioned within the fuel injector port such that the discharge end of the second fuel injector is inside the at least one intake channel.

28. The engine of claim 26, wherein each second fuel injector port is positioned within the fuel injector port such that the discharge end of the second fuel injector is substantially flush with a wall of the at least one intake channel.

29. The engine of claim 26 further comprising at least one second fuel source attached to the body member and configured to supply the second fuel to the second fuel injectors received in the fuel injector ports of the adapter device.

30. The engine of claim 29, wherein the at least one second fuel source comprises a first fuel rail and a second fuel rail, and wherein the first and second fuel rails are attached to opposing sides of the body member, and wherein each of the first and second fuel rails are attached to the body member with one or more brackets.

31. The engine of claim 29 further comprising a plurality of first fuel injectors for emitting the first fuel into the engine and at least one first fuel source for supplying the first fuel to the first fuel injectors.

32. The engine of claim 31, wherein the second fuel injectors emit the second fuel into the engine at a location that is upstream of the first fuel injectors.

33. The engine of claim 31, wherein the adapter device is installed between the upper and lower intake manifolds without removal of the first fuel injectors and the first fuel source.

34. The engine of claim 31, wherein the first fuel is gasoline fuel and the second fuel is compressed natural gas fuel, and wherein the first fuel injectors are gasoline fuel injectors and the second fuel injectors are compressed natural gas fuel injectors.

35. A method for converting an internal combustion engine to operate using a second fuel, comprising the steps of:
removing an upper intake manifold of the engine;
installing an adapter device on a lower intake manifold of the engine, the adapter device comprising: a body member having a top that mates with the upper intake manifold and a bottom that mates with the lower intake manifold; a plurality of intake channels formed in the body member, wherein each intake channel extends through the body member from the top to the bottom; and a plurality of fuel injector ports formed in the body member, each fuel injector port extending from a sidewall of the body member to at least one intake channel;
installing a plurality of fuel injectors for emitting the second fuel, wherein each fuel injector is received in one of the fuel injector ports of the adapter device, and wherein each fuel injector is positioned within the fuel injector port such that the second fuel is emitted directly into the at least one intake channel of the adapter device;
connecting the fuel injectors to at least one fuel source configured to supply the second fuel to the fuel injectors;
installing the upper intake manifold on the adapter device; and
securing the upper intake manifold to the adapter device and the lower intake manifold.

36. The method of claim 35 further comprising attaching the at least one fuel source to the body member of the adapter device.

37. The method of claim 35 further comprising aligning the intake channels of the adapter device with intake openings in the lower intake manifold.

38. The method of claim 35 further comprising using existing mounting holes in the upper and lower intake manifolds to secure the upper intake manifold to the adapter device and the lower intake manifold.

39. The method of claim 35, wherein the fuel injectors are installed without connection to or removal of a first fuel injector for emitting a first fuel into the engine.
